(19) United States
(12) Patent Application Publication
(10) Pub. No.: US 2006/0111499 A1
(43) Pub. Date: May 25, 2006

(54) Nanocomposite composition having high barrier property

(76) Inventors: Myung Ho Kim, Daejeon-city (KR); Minki Kim, Daejeon-city (KR); Sehyun Kim, Daejeon-city (KR); Youngtock Oh, Daejeon-city (KR); Jaeyong Shin, Daejeon-city (KR); Youngchul Yang, Daejeon-city (KR)

Correspondence Address: CANTOR COLBURN, LLP, 55 GRIFFIN ROAD SOUTH, BLOOMFIELD, CT, 06002, US

(21) Appl. No.: 11/254,631

(22) Filed: Oct. 20, 2005

(30) Foreign Application Priority Data
Nov. 19, 2004 (KR) 10-2004-0095057
Jun. 2, 2005 (KR) 10-2005-0047119

(51) Int. Cl. C08K 9/04

(52) U.S. Cl. 524/445

(57) ABSTRACT

A nanocomposite composition having a superior barrier property is provided. The nanocomposite composition includes a polypropylene resin and a polypropylene/intercalated clay nanocomposite. The nanocomposite composition has superior mechanical strength and superior barrier properties to oxygen, organic solvent, and moisture. Also, the nanocomposite composition can be used to prepare films, containers, or sheets having a superior barrier property through single/multi-layer blow molding.

### CROSS-REFERENCE TO RELATED PATENT APPLICATION

This application claims the benefit of Korean Patent Application No. 10-2004-0095057, filed on Nov. 19, 2004, and Korean Patent Application No. 10-2005-0047119, filed on Jun. 2, 2005, in the Korean Intellectual Property Office, the disclosures of which are incorporated herein in their entirety by reference.

### BACKGROUND OF THE INVENTION

1. Field of the Invention

The present invention relates to a nanocomposite composition having a high barrier property, and more particularly to a nanocomposite composition having superior mechanical strength and superior oxygen, organic solvent, and moisture barrier properties, which can be used to manufacture films, containers, or sheets through single/multi-layer blow molding.

2. Description of the Related Art

A polypropylene resin has superior heat resistance, chemical resistance and moisture barrier property. Blow-molded containers using the propylene resin are widely used in containers for foods, detergents, medical fluid and the like due to its superior rigidity and impact resistance. While the containers have a superior moisture barrier property, they have insufficient oxygen and organic solvent barrier properties. Therefore, containers for foods and medical liquors, which particularly require a high barrier property in order to prevent decomposition of contents, are manufactured with multi-layers by co-extrusion, lamination, coating, etc.

Multi-layer plastic products composed of an ethylene-vinyl alcohol (EVOH) copolymer and polyamide are transparent and have a good gas barrier property. However, because ethylene-vinyl alcohol copolymer and polyamide resins are more expensive than general-purpose resins, the amount of these resins used is limited, and ethylene-vinyl alcohol and polyamide resin layers must be formed as thin as possible.

To reduce the production costs of multi-layer plastic containers, a method of compounding ethylene-vinyl alcohol and polyamide resins with inexpensive polyolefin has been proposed. However, because ethylene-vinyl alcohol and polyamide are not very compatible with polyolefin, the blending is not easy. If ethylene-vinyl alcohol and polyamide are blended with polyolefin insufficiently, the mechanical properties of produced films or sheets become poor.

U.S. Pat. No. 4,971,864, U.S. Pat. No. 5,356,990, EP No. 15,556, and EP No. 210,725 disclose methods of using a compatibilizer prepared by grafting polyethylene with maleic anhydride. While this method improves an oxygen barrier property and mechanical strength, a moisture barrier property is poor due to the hydrophilic properties of ethylene-vinyl alcohol, polyamide resin and ionomers. Therefore, hydrophobic resin processing at the outermost layer is necessary, and there is no suitable processing condition for obtaining an effective barrier property morphology.

Due to the need to obtain the barrier property morphology, an interest in use of a nanocomposite of a resin having a barrier property and an intercalated clay is increasing.

As disclosed in U.S. Pat. Nos. 4,739,007, 4,618,528, 4,874,728, 4,889,885, 4,810,734, and 5,385,776, a nanocomposite contains fully exfoliated, partially exfoliated, intercalated, or partially intercalated platelets, tactoidal structures, or a dispersion mixture thereof, and intercalated clay having nanometer dimension is dispersed in a matrix polymer, such as an oligomer, a polymer, or a blend thereof.

In general, the manufacturing of nanocomposites is divided into two methods.

The first method is the manufacturing method of the above-described polyamide nanocomposite. In this method, monomers are inserted into intercalated organic clay, and the clay platelets are dispersed through inter-layer polymerization. This method is restricted in that it is applicable only when cationic polymerization is possible.

The other method is a melt compounding method in which melted polymer chains are inserted into intercalated clay and exfoliated through mechanical compounding.

However, when a molded article is manufactured using only the nanocomposite, it does not have a significantly improved barrier property.

Therefore, a study of a nanocomposite having superior mechanical strength and chemical barrier properties that is capable of maintaining an effective barrier property morphology after being molded is further required.

### SUMMARY OF THE INVENTION

The present invention provides a nanocomposite composition having superior mechanical strength and superior oxygen, organic solvent, and moisture barrier properties, which overcomes a limitation in a barrier property when polypropylene or a polypropylene/intercalated clay composite is used alone, while maintaining transparency of the polypropylene and can be used to manufacture films, containers, or sheets having a barrier property through single/multi-layer blow molding.

The present invention also provides a container or a film manufactured from said nanocomposite composition.

According to an aspect of the present invention, there is provided a dry-blended nanocomposite composition including: 40 to 97 parts by weight of a polypropylene resin; and 3 to 60 parts by weight of a polypropylene/intercalated clay nanocomposite.

In an embodiment of the present invention, the polypropylene may be at least one compound selected from the group consisting of a homopolymer of propylene, a random copolymer of propylene and ethylene, and a composite resin.

In another embodiment of the present invention, the intercalated clay may be at least one compound selected from the group consisting of montmorillonite, bentonite, kaolinite, mica, hectorite, fluorohectorite, saponite, beidelite, nontronite, stevensite, vermiculite, hallosite, volkonskoite, suconite, magadite, and kenyalite.

According to another aspect of the present invention, there is provided an article molded from said nanocomposite composition.

In an embodiment of the present invention, the article may be a container, a film, or a sheet.

When a nanocomposite is prepared by dispersing a nano-sized intercalated clay in a polypropylene resin, moisture and liquid barrier properties of the polypropylene resin are increased due to extended gas and liquid passage inside the resin and sagging of parison is suppressed during blow molding due to an increase in melt strength of the continuous polyproylene phase. However, when only the polypropylene nanocomposite is used, clay is randomly dispersed, and thus does not have directionality. In the present invention, the polypropylene nanocomposite is dry-blended with a continuous polypropylene phase having a different viscosity and put into a molding machine, and thus clay is oriented in one direction due to stretching effect during molding, thereby maximizing the barrier property.

### BRIEF DESCRIPTION OF THE DRAWINGS

The above and other features and advantages of the present invention will become more apparent by describing in detail exemplary embodiments thereof with reference to the attached drawing in which:

FIG. 1 is a schematic diagram of the morphology of a molded article manufactured from a nanocomposite composition having a barrier property according to an embodiment of the present invention.

### DETAILED DESCRIPTION OF THE INVENTION

The present invention will now be explained in more detail.

A dry-blended nanocomposite composition according to an embodiment of the present invention includes: 40 to 97 parts by weight of a polypropylene resin; and 3 to 60 parts by weight of a polypropylene/intercalated clay nanocomposite.

The polypropylene resin may be at least one compound selected from the group consisting of a homopolymer of propylene, a copolymer of propylene, metallocene polypropylene and a composite resin having improved physical properties by adding talc, flame retardant, etc. to a homopolymer or copolymer of propylene. As used herein, a composite resin means polypropylene having improved physical properties by adding talc, flame retardant, etc. to a base, such as a homopolymer or copolymer of propylene. The polypropylene resin may have a melt index (M.I.) of 1.3 to 15.0 under an ASTM D1238 condition (230° C., 2160 g). When the M.I. is less than 1.3, processibility is reduced and melt molding is difficult. When the M.I. is greater than 15.0, sagging of parison occurs, and thus it is not preferable.

The content of the polypylene resin in the nanocomposite composition is preferably 40 to 97 parts by weight, and more preferably 60 to 95 parts by weight. If the content of the polypropylene resin is less than 40 parts by weight, it is difficult to maintain its transparency. If the content of the polypropylene resin is greater than 97 parts by weight, the barrier property is not significantly improved.

The intercalated clay is preferably organic intercalated clay. The content of organic material in the intercalated clay is preferably 1 to 45 wt %.

The organic material has at least one functional group selected from the group consisting of from primary ammonium to quaternary ammonium, phosphonium, maleate, succinate, acrylate, benzylic hydrogen, oxazoline, and dimethyldistearylammonium.

The intercalated clay includes one or more materials selected from montmorillonite, bentonite, kaolinite, mica, hectorite, fluorohectorite, saponite, beidelite, nontronite, stevensite, vermiculite, hallosite, volkonskoite, suconite, magadite, and kenyalite; and the organic material preferably has a functional group selected from quaternary ammonium, phosphonium, maleate, succinate, acrylate, benzylic hydrogen, oxazoline, and dimethyldistearylammonium.

Polypropylene used in the preparation of the polypropylene/intercalated clay nanocomposite may be at least one compound selected from the group consisting of a homopolymer of propylene, a random copolymer of propylene and ethylene, and a composite resin. The polypropylene preferably has a M.I. of 1.3 to 15.0 under an ASTM D1238 condition (230° C., load of 2160 g). When the M.I. is less than 1.3, processibility is reduced and melt molding is difficult. When the M.I. is greater than 15.0, sagging of a parison occurs, and thus it is not preferable.

The content of the polypylene/intercalated clay composite in the nanocomposite composition is preferably 3 to 60 parts by weight, and more preferably 5 to 40 parts by weight.

If the content of the nanocomposite is less than 3 parts by weight, the barrier property is not significantly improved. If the content of the nanocomposite is greater than 60 parts by weight, it is difficult to obtain a barrier property morphology.

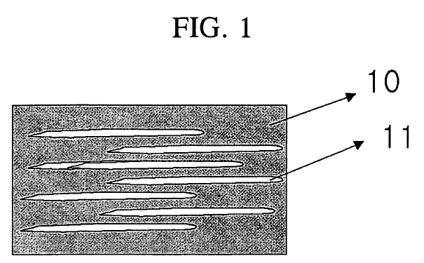

The polypropylene/intercalated clay nanocomposite offers favorable conditions to realize the morphology illustrated in FIG. 1, according to the contents of the intercalated clay. That is, FIG. 1 is a schematic cross-sectional view of a molded article manufactured from the nanocomposite composition according to an embodiment of the present invention. In FIG. 1, a discontinuous nanocomposite phase 11 is located in the continuous polypropylene phase 10. The finer the intercalated clay is exfoliated in the discontinuous polypropylene nanocomposite, the better the barrier properties that can be obtained. This is because the exfoliated intercalated clay forms a barrier film and thereby improves barrier properties and mechanical properties of the resin itself, and ultimately improves barrier properties and mechanical properties of the composition.

Accordingly, the ability to form a barrier to gas and liquid is maximized by compounding the polypropylene resin and the intercalated clay, and dispersing the nano-sized intercalated clay in the resin, thereby maximizing the contact area of the polymer chain and the intercalated clay.

The weight ratio of the polypropylene to the intercalated clay in the nanocomposite is 58.0:42.0 to 99.9:0.1, and preferably 85.0:15.0 to 99.0:1.0. If the weight ratio of the polypropylene to the intercalated clay is less than 58.0:42.0, the intercalated clay agglomerates and dispersing is difficult. If the weight ratio of the polypropylene to the intercalated clay is greater than 99.9:0.1, the improvement in the barrier properties is negligible.

The dry-blended nanocomposite composition can be used to form single-layered or multi-layered containers (bottles), sheets and films by blow molding, extrusion molding, injection molding, or pressure molding.

The molded articles according to the present invention can be manufactured using the following methods.

Manufacturing by Multiple Processes

The polypropylene/intercalated clay nanocomposite is prepared using a polymer compounder such as a single screw extruder, a co-rotation twin screw extruder, a counter-rotation twin screw extruder, a continuous compounder, a planetary gear compounder, a batch compounder, etc. Then, the nanocomposite is dry-blended with a matrix resin (polypropylene) in a constant ratio and directly put into a molding machine, thereby obtaining the final product.

Hereinafter, the present invention is described in more detail through examples. The following examples are meant only to increase understanding of the present invention, and are not meant to limit the scope of the invention.

### EXAMPLES

The materials used in the following examples are as follows:

PP: R724, R754 (LG Caltex, Korea)

Clay: SE3000 (SUD CHEMIE, Germany)

Thermal stabilizer: IR 1010 (Songwon Inc.)

### PREPARATION EXAMPLE 1

### (Preparation of Polypropylene/Intercalated Clay Nanocomposite)

97 wt % of a polypropylene random copolymer (copolymer of propylene and ethylene, R724, M.I.: 1.9 (ASTM D1238, 230° C., 2160 g)) were put in the main hopper of a twin screw extruder (SM Platek co-rotation twin screw extruder; Φ40). Then, 3 wt % of organic montmorillonite (SE3000) as an intercalated clay and 0.1 part by weight of IR 1010 as a thermal stabilizer based on total 100 parts by weight of the polypropylene random copolymer and the organic montmorillonite were simultaneously put in the main hopper of the twin screw extruder to prepare a polypropylene/intercalated clay nanocomposite in a pellet form. The extrusion temperature condition was 200-210-210-210-210-210-205° C., the screws were rotated at 300 rpm, and the discharge condition was 40 kg/hr.

### EXAMPLE 1

### (Biaxial Stretch Blow Molding)

20 parts by weight of the polypropylene nanocomposite prepared in the Preparation Example 1 and 80 parts by weight of polypropylene (R754) were dry-blended in a double cone mixer (MYDCM-100, MYEONG WOO MICRON SYSTEM) for 30 minutes and put in the main hopper of a biaxial stretch blow molding machine. The dry-blend was injected into a mold with a surface temperature of 23° C. under the processing temperature condition of 210-240-240-240° C. and an injection pressure of 50 kg/cm² to form a parison. Then, the parison was removed from the mold. The parison had a neck-portion with a diameter of 24.0 mm and a body portion with a length of 40 mm and a thickness of 3.5 mm. An injection time was 6.7 seconds and a cooling time was 2.3 seconds. The surface temperature of the parison body was 105° C. The obtained hot parison was put into a blow mold and a stretch load was introduced inside the parison to stretch a low portion of the parison in a longitudinal direction. In the final stage of the longitudinal stretching, pressurized air with a pressure of 10 kgf/cm² was blown for 5 seconds to provide a biaxially stretched bottle. The temperature of the blow mold was 13° C. The bottle was cooled and removed from the blow mold. A body of the bottle had a height of about 90 mm, a diameter of about 60 mm, and a thickness of about 0.5 mm.

### EXAMPLE 2

### (Direct Blow Molding)

20 parts by weight of the polypropylene nanocomposite prepared in the Preparation Example 1 and 80 parts by weight of polypropylene (R754) were dry-blended in a double cone mixer (MYDCM-100, MYEONG WOO MICRON SYSTEM) for 30 minutes. Then, the dry-blend was put in the main hopper of a blow-molding machine to form a parison under the processing temperature condition of 200-220-200-200° C. at an extrusion rate of 10 kg/hr. Next, the parison was put into a mold at a temperature of 25° C. The mold was closed and air was blown into the parison. The parison was cooled, and then removed from the mold. The parison had an inner diameter of 36 mm, an outer diameter of 40 mm, and a body thickness of about 2 mm. The parison was put into a blow mold and pressurized air with a pressure of 5 kgf/cm² was blown into the parison for 20 seconds to stretch the parison in a transverse direction, thereby obtaining a container. The container had an inner height of 140 mm, a diameter of 80 mm, and a body thickness of about 0.5 mm.

### EXAMPLE 3

### (Direct Blow Molding)

20 parts by weight of the polypropylene nanocomposite prepared in the Preparation Example I and 80 parts by weight of polypropylene (R754) were put into a main hopper of a blow molding machine through belt-type feeders K-TRON Nos. 1 and 2, respectively, in a dry-blended state to form a parison under the processing temperature condition of 200-220-200-200° C. at an extrusion rate of 10 kg/hr. Next, the parison was put into a mold at a temperature of 25° C. The mold was closed and air was blown into the parison. The parison was cooled, and then removed from the mold. The parison had an inner diameter of 36 mm, an outer diameter of 40 mm, and a body thickness of about 2 mm. The parison was put into a blow mold and pressurized air with a pressure of 5 kgf/cm² was blown into the parison for 20 seconds to stretch the parison in a transverse direction, thereby obtaining a container. The container had an inner height of 140 mm, a diameter of 80 mm, and a body thickness of about 0.5 mm.

### EXAMPLE 4

### (Direct Blow Molding)

5 parts by weight of the polypropylene nanocomposite prepared in the Preparation Example 1 and 95 parts by weight of polypropylene (R754) were put into a main hopper of a blow molding machine through belt-type feeders K-TRON Nos. 1 and 2, respectively, in a dry-blended state to form a parison under the processing temperature condition of 200-220-200-200° C. at an extrusion rate of 10 kg/hr. Next, the parison was put into a mold at a temperature of 25° C. The mold was closed and air was blown into the parison. The parison was cooled, and then removed from the mold. The parison had an inner diameter of 36 mm, an outer diameter of 40 mm, and a body thickness of about 2 mm. The parison was put into a blow mold and pressurized air with a pressure of 5 kgf/cm² was blown into the parison for 20 seconds to stretch the parison in a transverse direction, thereby obtaining a container. The container had an inner height of 140 mm, a diameter of 80 mm, and a body thickness of about 0.5 mm.

### EXAMPLE 5

### (Direct Blow Molding)

45 parts by weight of the polypropylene nanocomposite prepared in the Preparation Example 1 and 55 parts by weight of polypropylene (R754) were put into a main hopper of a blow molding machine through belt-type feeders K-TRON Nos. 1 and 2, respectively, in a dry-blended state to form a parison under the processing temperature condition of 200-220-200-200° C. at an extrusion rate of 10 kg/hr. Next, the parison was put into a mold at a temperature of 25° C. The mold was closed and air was blown into the parison. The parison was cooled, and then removed from the mold. The parison had an inner diameter of 36 mm, an outer diameter of 40 mm, and a body thickness of about 2 mm. The parison was put into a blow mold and pressurized air with a pressure of 5 kgf/cm² was blown into the parison for 20 seconds to stretch the parison in a transverse direction, thereby obtaining a container. The container had an inner height of 140 mm, a diameter of 80 mm, and a body thickness of about 0.5 mm.

### COMPARATIVE EXAMPLE 1

A container was manufactured in the same manner as in Example 1 using a pellet composed of only polypropylene (R754).

### COMPARATIVE EXAMPLE 2

A container was manufactured in the same manner as in Example 2 using a pellet composed of only polypropylene (R754).

### COMPARATIVE EXAMPLE 3

The same procedure of Example 1 was carried out, except that only polypropylene (R724) was used as a discontinuous phase without the organic montmorillonite as an intercalated clay and polypropylene (R754) with a viscosity different from the discontinuous phase was used as a continuous phase.

### COMPARATIVE EXAMPLE 4

The same procedure of Example 2 was carried out, except that only polypropylene (R724) was used as a discontinuous phase without the organic montmorillonite as an intercalated clay and polypropylene (R754) with a viscosity different from the discontinuous phase was used as a continuous phase.

### EXPERIMENTAL EXAMPLE

For the blow-molded containers manufactured in Examples 1 through 5 and Comparative Examples 1 through 4, liquid and gas barrier properties were determined by the following method. The results are shown in Table 1.

a) Liquid barrier properties

500 g of each of Toluene, Desys herbicide (1% of deltametrine+emulsifier, stabilizer, and solvent; Kyung Nong), Batsa insecticide (50% of BPMC+50% of emulsifier and solvent), and water was put in the containers manufactured in Examples 1 to 5 and Comparative Examples 1 to 4. Then, the weight change was determined after 30 days under a condition of forced exhaust at 50° C. For toluene, the weight change was further determined at room temperature (25° C.).

b) Oxygen and moisture barrier properties

The containers blow-molded in Examples 1 to 5 and Comparative Examples 1 to 4 were left alone under a temperature of 23° C. and a relative humidity of 50% for 1 day. Then, the gas penetration rate was determined (Mocon OX-TRAN 2/20, U.S.A).

TABLE 1
Oxygen and Moisture Barrier Properties

| | Oxygen | |
|---|---|---|
| | (cm²/m² · 24 | Moisture |
| | hrs · atm) | (g/m² · 24 hrs) |
| Example 1 | 364.7 | 0.94 |
| Example 2 | 528.3 | 1.01 |
| Example 3 | 545.1 | 1.02 |
| Example 4 | 1103.8 | 0.91 |
| Example 5 | 285.4 | 1.07 |
| Comparative Example 1 | 1234.9 | 1.11 |
| Comparative Example 2 | 1518.3 | 1.26 |
| Comparative Example 3 | 1130.6 | 1.07 |
| Comparative Example 4 | 1285.3 | 1.14 |

TABLE 2
Liquid Barrier Property

| | Liquid barrier property (%) | | | | |
|---|---|---|---|---|---|
| | Weight change | | | | |
| | at 25° C. | Weight change at 50° C. | | | |
| | Toluene | Toluene | Desys | Batsa | Water |
| Example 1 | 0.84 | 3.28 | 1.58 | 0.96 | 0.0034 |
| Example 2 | 1.26 | 4.53 | 1.89 | 1.22 | 0.0038 |
| Example 3 | 1.28 | 4.62 | 1.90 | 1.24 | 0.0037 |
| Example 4 | 2.61 | 5.08 | 2.77 | 1.54 | 0.0047 |
| Example 5 | 0.52 | 2.14 | 1.05 | 0.91 | 0.0047 |
| Comparative | 2.84 | 6.40 | 2.89 | 1.57 | 0.0049 |
| Example 1 | | | | | |
| Comparative | 3.32 | 8.30 | 3.18 | 2.55 | 0.0051 |
| Example 2 | | | | | |
| Comparative | 2.65 | 5.14 | 3.20 | 1.84 | 0.0057 |
| Example 3 | | | | | |
| Comparative | 2.88 | 6.17 | 3.62 | 2.42 | 0.0068 |
| Example 4 | | | | | |

As shown in Tables 1 and 2, molded articles manufactured from nanocomposite compositions of Examples 1 to 5 according to the present invention show better barrier properties to liquid and gas than those of Comparative Examples 1 to4.

As described above, the nanocomposite composition of the present invention has superior mechanical strength and superior barrier properties to oxygen, organic solvent, and moisture. Also, the nanocomposite composition can be used to prepare containers, sheets, or films having a superior barrier property through single/multi-layer blow molding.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A dry-blended nanocomposite composition comprising:
40 to 97 parts by weight of a polypropylene resin; and
3 to 60 parts by weight of a polypropylene/intercalated clay nanocomposite.

2. The nanocomposite composition of claim 1, wherein the propylene resin is at least one compound selected from the group consisting of a homopolymer of propylene, a random copolymer of propylene and ethylene, and a composite resin.

3. The nanocomposite composition of claim 1, wherein the intercalated clay in the nanocomposite is at least one compound selected from the group consisting of montmorillonite, bentonite, kaolinite, mica, hectorite, fluorohectorite, saponite, beidelite, nontronite, stevensite, vermiculite, hallosite, volkonskoite, suconite, magadite, and kenyalite.

4. The nanocomposite composition of claim 1, wherein the intercalated clay comprises 1 to 45 wt % of organic material.

5. The nanocomposite composition of claim 4, wherein the organic material has at least one functional group selected from the group consisting of from primary ammonium to quaternary ammonium, phosphonium, maleate, succinate, acrylate, benzylic hydrogen, oxazoline, and dimethyldistearylammonium.

6. The nanocomposite composition of claim 1, wherein the polypropylene resin and the polypropylene in the composite have a melt index (M.I.) of 3 to 15 g/min under an ASTM D1238 condition (2160 g, 230° C.).

7. The nanocomposite composition of claim 1, wherein the polypropylene in the composite is at least one compound selected from the group consisting of a homopolymer of propylene, a copolymer of propylene, metallocene polypropylene and a composite resin having improved physical properties by adding talc, flame retardant, etc. to a homopolymer or copolymer of propylene.

8. The nanocomposite composition of claim 1, wherein the weight ratio of the polypropylene to the intercalated clay in the nanocomposite is 58.0:42.0 to 99.9:0.1

9. An article manufactured by molding the nanocomposite composition of claim 1.

10. The article of claim 9, which is a container, a film, a pipe, or a sheet.

11. The article of claim 9, manufactured through blow molding, extrusion molding, pressure molding, or injection molding.
